(19) United States
(12) Patent Application Publication
(10) Pub. No.: US 2016/0187536 A1
(43) Pub. Date: Jun. 30, 2016

(54) NON-VOLATILE PHOTONIC MATERIAL AND PRODUCTION METHOD OF THE SAME

(71) Applicants: NATIONAL UNIVERSITY CORPORATION NAGOYA UNIVERSITY, Nagoya-shi (JP); MASSACHUSETTS INSTITUTE OF TECHNOLOGY, Cambridge, MA (US)

(72) Inventors: Atsushi NORO, Nagoya-shi (JP); Yusuke TOMITA, Nagoya-shi (JP); Satoru MATSUSHIMA, Nagoya-shi (JP); Yoshio SAGESHIMA, Nagoya-shi (JP); Yushu MATSUSHITA, Nagoya-shi (JP); Joseph J. WALISH, Brighton, MA (US); Edwin L. THOMAS, Houston, TX (US)

(21) Appl. No.: 14/891,234

(22) PCT Filed: May 13, 2014
(86) PCT No.: PCT/JP2014/062747

§ 371 Date: Feb. 17, 2016

(30) Foreign Application Priority Data
May 13, 2013 (JP) 2013-101409

(51) Int. Cl. G02B 1/04; B05D 3/10; B05D 5/06

(52) U.S. Cl. CPC G02B 1/04; B05D 5/063; B05D 3/107

(57) ABSTRACT

A photonic material capable of reflecting part of the light rays in a wavelength region from near-ultraviolet light to near-infrared light. The photonic material contains a block copolymer including a plurality of different polymer chains connected to one another. Each polymer chain independently forms a portion of an aggregated nanophase separated structure. At least one of the plurality of polymer chains is swelled with a non-volatile solvent. An example of such a photonic material may be a polystyrene-b-poly(2-vinylpyridine) block copolymer whose poly(2-vinylpyridine) phase is swelled with an ionic liquid.

### TECHNICAL FIELD

The present invention relates to a non-volatile photonic material and a method for producing the same.

### BACKGROUND ART

It is known that block copolymers made up of different incompatible polymers connected to one another form regular periodic structures in which heterologous domains of several nanometers to several hundreds of nanometers are phase-separated, that is, nanophase-separated structures (may also be referred to as microphase-separated structures or mesophase-separated structures) (NPL 1). On the other hand, a photonic material has a periodic nanostructure made of different components having different refractive indices, and a one-dimensional photonic material having a one-dimensionally repetitive structure reflects light having a specific wavelength. Accordingly, a photonic material can be produced from a block copolymer containing components having different dielectric constants or, in practice, different refractive indices (PTL 1, PTL 2). For forming a nanostructure exhibiting photonic crystal properties for visible light, that is, forming a nanophase-separated structure of several hundreds of nanometers or more, a polymer having a molecular weight as high as at least about 500 thousands is required. Thus, the practical use and production of such a nanostructure have been limited.

Thomas et al. proposed a method as a solution of this issue for forming a one-dimensional photonic film by swelling a thin film of a block copolymer having a molecular weight of about 400 thousands with water (PTL 3, NPL 2). More specifically, a solution of a polystyrene-b-poly(2-vinylpyridine) block copolymer is applied onto the surface of a slide glass by spin coating, and then the coated film is exposed to chloroform vapor at 50° C. for solvent annealing. After the completion of annealing, poly(2-vinylpyridine) blocks are cross-linked with dibromopropane, and water is applied to the resulting cross-linked film. Thus, the films can be produced, which can reflect light rays having various wavelengths (in a wavelength region including visible light) according to the degree of cross-linking of the film.

Thomas et al. also proposed an improved method for forming a one-dimensional photonic film by swelling a thin film of a block copolymer having a molecular weight of about 200 thousands with methanol (NPL 3). This method does not require a cross-linking step. More specifically, a solution of a polystyrene-b-poly(2-vinylpyridine) block copolymer is applied onto the surface of a slide glass by spin coating, and then the coated film is exposed to chloroform vapor at 40° C. for solvent annealing. After the completion of annealing, trifluoroethanol is applied to the coating film to yield a film that reflects blue light.

Furthermore, Thomas et al. proposed a method for forming a one-dimensional photonic gel by turning a thin film of a block copolymer having a molecular weight of about 100 thousands into a quaternary salt film in a 1-bromoethane solution (NPL 4). More specifically, a solution of a polystyrene-b-poly(2-vinylpyridine) block copolymer is applied onto the surface of a slide by spin coating, and then the coated film is exposed to chloroform vapor at 50° C. for solvent annealing. After the completion of annealing, the thin film is immersed in a 50° C. solution of 1-bromoethane in hexane to convert the polymer into a quaternary salt, and then water is applied to the film to yield a gel film.

Photonic thin films of such block copolymers are also expected to be used as mechanochromic materials, thermochromic materials, or electrochromic materials (NPLs 3, 5 and 6).

### CITATION LIST

### Non Patent Literature

NPL 1: Kobunshi Ronbunshu, Vol. 63, pp. 205-218, 2006
NPL 2: Nature Materials, Vol. 6, pp. 957-960, 2007
NPL 3: Advanced Materials, Vol. 21, pp. 3078-3081, 2009
NPL 4: ACS Nano, Vol. 6, pp. 8933-8939, 2012
NPL 5: Advanced Materials, Vol. 23, pp. 4702-4706, 2011
NPL 6: Macromolecules Vol. 41, pp. 4582-4584, 2008

### Patent Literature

PTL 1: U.S. Patent Application Publication No. 2002/6433931
PTL 2: U.S. Patent Application Publication No. 2003/6671097
PTL 3: U.S. Patent Application Publication No. 2013/0015417

### SUMMARY OF THE INVENTION

### Technical Problem

Unfortunately, the nanostructures of the photonic films disclosed in NPLs 2 to 6 are returned to the original sizes by evaporation of the solvent therefrom, and accordingly, the properties of the photonic material are gradually lost over time at room temperature in the air. In addition, such photonic films are difficult to use as mechanochromic materials, thermochromic materials, or electrochromic materials.

The present invention is intended to solve these issues, and a major object of the present invention is to provide a non-volatile photonic material that reflects a part of light rays in a wavelength region from near-ultraviolet light to near-infrared light over a long time.

### Solution to Problem

To accomplish the object, the present inventors added a non-volatile solvent to a coated film formed by applying a solution containing a block copolymer onto the surface of a substrate by spin coating, followed by annealing. As a result, the present inventors found that the film can reflect a part of light rays in a wavelength region from near-ultraviolet light to near-infrared light, and thus achieved the present invention.

Specifically, the non-volatile photonic material of the present invention is a photonic material capable of reflecting a part of light rays in a wavelength region from near-ultraviolet light to near-infrared light, containing a block copolymer including a plurality of different polymer chains connected to one another, forming a nanophase separated structure, where each polymer chain independently is aggregated. At least one of the plurality of polymer chains is swelled with a non-volatile solvent.

The present invention also provides a method for producing a non-volatile photonic material being a photonic material capable of reflecting a part of light rays in a wavelength region from near-ultraviolet light to near-infrared light. The method includes forming, on a substrate, a thin film of a block copolymer including a plurality of different polymer chains connected to one another, and swelling the thin film with a non-volatile solvent.

### Advantageous Effects of Invention

The non-volatile photonic material of the present invention has a nanophase-separated structure. The phases forming the nanophase-separated structure are made of different polymer chains. At least one of the polymer chains is swelled with a non-volatile solvent (but not meaning simply being soaked with or dissolved in the solvent). Accordingly, the photonic material of the present invention reflects light rays in a wider wavelength region in comparison with the case where no polymer chains are swelled, and thus reflects a part of light rays in a wavelength region from near-ultraviolet light to near-infrared light. Also, since the photonic material of the present invention is produced by swelling polymer chains in a non-volatile solvent, but not in a volatile solvent, the swelled polymer chains are not returned to the unswelled initial state by evaporation of the solvent during storage. Thus the photonic material can reflect a part of light rays in a wavelength region from near-ultraviolet light to near-infrared light over a long time.

### BRIEF DESCRIPTION OF DRAWINGS

FIG. 1 shows reflection spectra of photonic films (on a quartz substrate) of Examples 1 to 4.

FIG. 2 shows a reflection spectrum of a photonic film (on a quartz substrate) of Example 1 after about 100 days.

FIG. 3 shows TEM micrographs, (a) showing the state before adding an ionic liquid, (b) showing the state after adding the ionic liquid.

FIG. 4 shows SEM micrographs, (a) showing the state before adding an ionic liquid, (b) showing the state after adding the ionic liquid.

FIG. 5 shows small-angle X-ray scattering profiles, (a) showing a profile before adding an ionic liquid, (b) showing a profile after adding the ionic liquid.

FIG. 6 shows reflection spectra of photonic films (on a glass substrate) of Examples 5 to 9.

FIG. 7 shows a plot of the relationship between the wavelength of primary peaks in reflection spectra and the molecular weight.

FIG. 8 shows a plot of the relationship between the ImHTFSI content (wt %) and the wavelength of primary peaks in reflection spectra.

FIG. 9 shows reflection spectra of photonic films (on a glass substrate) of Examples 14 and 15.

FIG. 10 shows reflection spectra of photonic films (on a glass substrate) of Examples 16 and 17.

FIG. 11 shows reflection spectra of photonic films (on a glass substrate) of Examples 18 and 19.

FIG. 12 shows a reflection spectrum of a photonic film (on a glass substrate) of Example 20.

FIG. 13 shows a reflection spectrum of a photonic (on a glass substrate) of Example 21.

### DESCRIPTION OF EMBODIMENTS

The non-volatile photonic material of the present invention is a photonic material capable of reflecting a part of light rays in a wavelength region from near-ultraviolet light to near-infrared light, and contains a block copolymer including a plurality of different polymer chains connected to one another. The block copolymer forms a nanophase-separated structure, where each polymer chain independently is aggregated. At least one of the plurality of polymer chains is swelled with a non-volatile solvent.

In the non-volatile photonic material of the present invention, the block copolymer includes a plurality of different polymer chains connected to one another, and the block copolymer forms a nanophase-separated structure, where each polymer chain independently is aggregated. Although the block copolymer may be made up of two different polymer chains connected to each other or three different polymer chains connected to one another, preferred is a block copolymer made up of two different polymer chains connected to each other. That is, the block copolymer preferably has a first polymer and a second polymer that are connected to each other.

In this instance, the first polymer chain is preferably a polystyrene or a polydiene. Examples of polystyrenes include polystyrene, polymethylstyrene, polydimethylstyrene, polytrimethylstyrene, polyethylstyrene, polyisopropylstyrene, polychloromethylstyrene, polymethoxystyrene, polyacetoxystyrene, polychlorostyrene, polydichlorostyrene, polybromostyrene, and polytrifluoromethylstyrene. Examples of the polydiene include polybutadiene and polyisoprene.

The second polymer chain is preferably any of the polyvinylpyridines, polyacrylic acid, polyacrylic acid esters, polymethacrylic acid and esters thereof, polyvinylpyrrolidone, and polyvinylimidazole. Exemplary polyvinylpyridines include poly(2-vinylpyridine), poly(3-vinylpyridine), and poly(4-vinylpyridine). Exemplary polyacrylic acid esters include poly(methyl acrylate), poly(ethyl acrylate), poly(butyl acrylate), poly(isobutyl acrylate), poly(hexyl acrylate), poly(2-ethylhexyl acrylate), poly(phenyl acrylate), poly(methoxyethyl acrylate), and poly(glycidyl acrylate). Exemplary polymethacrylic acid esters include poly(methyl methacrylate), poly(ethyl methacrylate), poly(butyl methacrylate), poly(isobutyl methacrylate), poly(hexyl methacrylate), poly(2-ethylhexyl methacrylate), poly(isodecyl methacrylate), poly(lauryl methacrylate), poly(phenyl methacrylate), and poly(methoxyethyl methacrylate). The second polymer chain is swelled to a larger size with a non-volatile solvent than the first polymer chain.

In the non-volatile photonic material of the present invention, the block copolymer is preferably a polystyrene-b-poly(2-vinylpyridine) block copolymer, a polystyrene-b-poly(methyl methacrylate) block copolymer, or the like.

In the non-volatile photonic material of the present invention, the block copolymer forms a nanophase-separated structure, where each polymer chain independently is aggregated. The nanophase-separated structure may be a spherical structure, a cylindrical structure or a lamellar structure, and a lamellar structure is preferred. Also, the block copolymer may be a combination of, for example, non-polar/polar, polar/polar, or non-polymer electrolyte/polymeric electrolyte. Furthermore, the block copolymer may have a bicontinuous structure or a quasiperiodic structure. The non-volatile photonic material of the present invention may further contain another block copolymer or a homopolymer in addition to the block copolymer being the main constituent and the non-volatile solvent. If the photonic material contains a plurality of block copolymers, the proportion of the contents thereof can be arbitrarily set.

In the non-volatile photonic material of the present invention, the total molecular weight of the block copolymer is not particularly limited, but is preferably 50,000 or more, more preferably 80,000 or more. If the molecular weight is less than 50,000, there is a risk that the block copolymer cannot reflect light in a wavelength region from near-ultraviolet light to near-infrared light even though one of the polymer chains is swelled. This is undesirable. The wavelength of light reflected from the photonic material of the present invention can be adjusted by adjusting the molecular weight of the block copolymer. The block copolymer may be in a coil-coil form, a rod-coil form, or a rod-rod form.

In the non-volatile photonic material of the present invention, at least one of the plurality of different polymer chains of the block copolymer is swelled with a non-volatile solvent. The non-volatile solvent refers to a solvent that has a very low vapor pressure and is in a liquid state at room temperature (at any temperature of 10° C. to 50° C.) under normal pressure (under any pressure of 950 hPa to 1100 hPa). The term very low vapor pressure implies that the solvent maintains 99% or more of the mass thereof at room temperature even by being allowed to stand at room temperature under normal pressure for 24 hours. The polymer chains are preferably such that they are swelled by interaction with the non-volatile solvent. The interaction may be, for example, hydrogen bonding or ionic interaction. The non-volatile solvent may be a non-volatile protic solvent or a non-volatile solvent containing the non-volatile protic solvent. In this instance, it is preferable that the polymer chains be swelled by receiving protons from the protic solvent. The term non-volatile protic solvent refers to a solvent containing a proton-donating group, such as O—H or N—H, having such a low vapor pressure that it is liquid at room temperature under normal pressure. Alternatively, the non-volatile solvent may be a non-volatile solvent capable of receiving protons or a non-volatile solvent containing a non-volatile solvent capable of receiving protons. In this instance, it is preferable that the polymer chain is protic so as to donate protons to the non-volatile solvent and capable of being swelled.

Preferably, the non-volatile protic solvent is a protic ionic liquid. The protic ionic liquid may be an ionic liquid made up of a salt of a nitrogen-containing heterocycle having a proton on the nitrogen thereof or an ionic liquid made up of an ammonium salt of an organic amine having a proton on the nitrogen thereof. Examples of the former of the ionic liquids include imidazolium salts, triazolium salts, pyridinium salts, and pyrrolidinium salts. Preferred are imidazolium salts, triazolium salts and pyridinium salts. The latter of the ionic liquids may be an alkylammonium salt. Examples of the imidazolium salts include bis(trifluoromethylsulfonyl)imide (may be referred to as TFSI or TFSA, and hereinafter referred to uniformly as TFSI) salt of imidazolium; acetate, TFSI salt or bis(pentafluoroethanesulfonyl)imide (BETI) salt of 1-methylimidazolium; trifluoromethanesulfonic acid (TfO) salt or perchloric acid salt of 1-ethylimidazolium; BETI salt or perchloric acid salt of 1-ethyl-2-methylimidazolium; TFSI salt or BETI salt of 1,2-dimethylimidazolium. The triazolium salt may be TFSI salt of 1,2,4-triazolium. The pyridinium salt may be trifluoroacetic acid (TFA) salt of 2-methylpyridinium. The pyrrolidinium salt may be nitric acid salt or phenolcarboxylic acid salt of 2-pyrrolidinium. Examples of the alkylammonium salt include nitric acid salt of ethylammonium, TFA salt or nitric acid salt of propylammonium, thiocyanic acid salt or TFSI salt of butylammonium, Tfo salt of tert-butylammonium, tetrafluoroboronic acid (BF_{F}) salt of ethanolammonium, TFSI salt or BF4 salt of alanine methyl ester, nitric acid salt of alanine ethyl ester, nitric acid salt of isoleucine methyl ester, nitric acid salt of threonine methyl ester, nitric acid salt of proline methyl ester, nitric acid salt of bis(proline ethyl ester), butyric acid salt of 1,1,3,3-tetramethylguanidinium, thiocyanic acid salt of dipropylammonium, nitric acid salt of dipropylammonium, thiocyanic acid salt of 1-methylpropylammonium, TFSI salt of triethylammonium, methanesulfonic acid salt of triethylammonium, nitric acid salt of tributylammonium, and sulfuric acid salt of dimethylethylammonium.

For a protic ionic liquid produced by synthesis performed by mixing a base (for example, 1-ethylimidazole) and an acid (for example, trifluoromethanesulfonic acid), even if the ratio of base to acid is not 1:1, the resulting liquid is considered to be a protic ionic liquid as long as it is non-volatile at room temperature under normal pressure. For a protic ionic liquid produced by mixing a salt (for example, alanine ethyl ester hydrochloride) and a salt (for example, lithium trifluoromethanesulfonate), even if the resulting liquid contains solid salt (in this case, lithium chloride), the liquid is considered to be the protic ionic liquid as long as it is non-volatile at room temperature and normal pressure.

In general, a composite material of layers having different refractive indices stacked in a periodicity of 100 nm to 250 nm reflects light having a specific wavelength. Such a material is called a one-dimensional phonic crystal. Block copolymers form periodic structures on the order of nanometers, and are called nanophase-separated structures. Therefore if a nanophase-separated structure (such as a lamellar structure) is large in a periodicity size, the structure can be used as a one-dimensional photonic crystal. The photonic material of the present invention is a material adapted to reflect light in a visible light region by swelling one of the polymer chains with a non-volatile solvent so as to increase the structural period to a relatively large size (for example, 130 nm to 300 nm). Since the polymer chains are swelled with a non-volatile solvent, the photonic material can reflect a part of light rays in a wavelength region from near-ultraviolet light to near-infrared light almost permanently.

A method for producing such a non-volatile photonic material of the present invention will now be described. First, a thin film is formed on a substrate using a solution containing a block copolymer made up of a plurality of different polymer chains connected to one another. Then, the thin film is swelled with a non-volatile solvent. Thus, the above-described non-volatile photonic material of the present invention is produced. After being formed, the thin film may be annealed in the vapor of a solvent.

In the step of forming a thin film on a substrate using a solution containing the block copolymer, the thin film may be formed by any process without particular limitation as far as the thin film can be formed. For example, a generally used method may be used, such as spin coating, solvent casting, dip coating, roll coating, curtain coating, slide coating, extrusion, bar coating, or gravure coating. From the viewpoint of productivity or the like, spin coating is advantageous. The conditions for the spin coating may be appropriately set according to the block copolymer to be used. The thickness of the thin film is, for example, but is not limited to, about 0.5 μm to 10 μm.

If the step of annealing the thin film in the vapor of a solvent is performed, the solvent can be appropriately selected according to the block copolymer. Examples of the solvent include halogenated hydrocarbon solvents, such as chloroform, and ether solvents, such as THF. The annealing time can also be set according to the block copolymer. For example, it may be 6 to 48 hours at 30° C. to 90° C. This annealing allows the block copolymer to be stabilized in a nanophase-separated structure (for example, lamellar structure) that is a thermodynamically stable structure.

In the step of swelling the thin film with a non-volatile solvent, the above-cited non-volatile solvents can be used. In this step, the non-volatile solvent is dropped on the thin film, and after the solvent is allowed to permeate into the entire thin film, at least one of the plurality of polymer chains of the block copolymer is swelled with a non-volatile solvent by heating at 30° C. to 90° C. The temperature and time for heating may be appropriately set according to the block copolymer and non-volatile solvent to be used.

The present invention is not limited to the above-described embodiment, and it should be appreciated that various forms can be applied to the invention within the technical scope of the invention.

### EXAMPLES

### Example 1

Polystyrene-b-poly(2-vinylpyridine) (hereinafter referred to as “PS-P2VP”) was synthesized as an AB diblock copolymer with reference to a block copolymer synthesis method (high-vacuum breakable sealing method) disclosed in Polymer Journal 18, pp. 493-499 (1986). A procedure will be shown in detail below.

The interior of a high-vacuum reactor was washed with a solution of α-styrene tetramer disodium in THF. A THF solution (1.92×10⁻² M, 5.5 mL) of cumyl potassium synthesized by a reaction of cumyl methyl ether and metallic potassium was introduced into the high-vacuum reactor, and then 300 mL of highly purified THF was added. After the reactor was cooled to −78° C. and the content in the reactor was sufficiently stirred, a solution of styrene monomer in THF (1.92 M, 25 mL) was introduced into the reactor, and thus anionic polymerization was started. After 15 minutes, a solution of 2-vinylpyridine monomer in THF (1.92 M, 25 mL) was introduced into the reactor, and thus block copolymerization was started. After 5 hours, isopropanol was added as a terminating agent to stop the polymerization. The resulting PS-P2VP was collected by precipitation purification in hexane.

The purified PS-P2VP was dissolved in DMF to yield 0.1 wt % solution, and the solution was subjected to gel permeation chromatography (GPC). Thus the molecular weight distribution (Mw/Mn) was determined. The measurement was performed at a flow rate of 1 mL/min using DMF as an eluent in a state where three columns of TSK-GEL column G4000 HHR manufactured by Tosoh were connected in series. A polystyrene standard was used for molecular weight calibration. The molecular weight distribution Mw/Mn was 1.12. The proportion (volume fraction φs) of PS was determined by measurement using UNITY-INOVA 500 MHz nuclear magnetic resonator manufactured by Varian, and the result was 0.50. Also, the total molecular weight Mn of the block copolymer was obtained by membrane osmotic pressure measurement, and the result was 78 k. Thus obtained PS-P2VP is hereinafter referred to as SP01.

The resulting SP01 was dissolved in 1,4-dioxane to prepare 7 wt % solution thereof. Subsequently, this solution was dropped on a quartz slide glass and subjected to spin coating using a spin coater (1H-DX2 manufactured by Mikasa) at a spin coat rotation speed of 500 rpm for 60 seconds to form a thin film of about 2 μm in thickness. Subsequently, the resulting thin film was annealed in the vapor of a solvent for optimizing the SP01 nanophase-separated structure in the thin film. Specifically, the annealing was performed in chloroform vapor at 40° C. for 12 hours. Subsequently, an ionic liquid was dropped on the annealed thin film and spread over the surface of the thin film with a Pasteur pipette so as to permeate into the entire thin film. Then, the thin film was heated at 40° C. for about 1 hour on a hot plate, thus being swelled to the maximum. Thus a photonic film of Example 1 was produced.

In the present Example, a protic liquid ImHTFSI (see Chem. 1) prepared by mixing imidazole and bis(trifluoromethylsulfonyl)imide in a mole ratio of 7:3 was used as the ionic liquid. This ionic liquid had a glass transition temperature Tg of about −77° C., a melting point Tm of about 12° C., and a refractive index nD of 1.44 (20° C.).

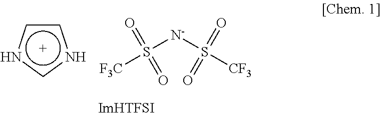

### Example 2

PS-P2VP was synthesized in the same manner as in Example 1, except that a solution of cumyl potassium in THF (1.92×10⁻² M, 4.2 mL) was used. The resulting PS-P2VP was Mw/Mn=1.14, φs=0.47, and Mn=108 k. Thus obtained PS-P2VP is hereinafter referred to as SP02. Using this SP02, a photonic film of Example 2 was produced in the same manner as in Example 1.

### Example 3

PS-P2VP was synthesized in the same manner as in Example 1, except that a solution of cumyl potassium in THF (1.92×10⁻² M, 3.2 mL) was used. The resulting PS-P2VP was Mw/Mn=1.06, φs=0.50, and Mn=158 k. Thus obtained PS-P2VP is hereinafter referred to as SP03. Using the SP03, a photonic film of Example 3 was produced in the same manner as in Example 1.

### Example 4

PS-P2VP was synthesized in the same manner as in Example 1, except that a solution of cumyl potassium in THF (1.92×10⁻² M, 1.4 mL) was used and that annealing was preformed using THF vapor. The resulting PS-P2VP was Mw/Mn=1.10, φs=0.51, and Mn=334 k. Thus obtained PS-P2VP is hereinafter referred to as SP04. Using this SP04, a photonic film of Example 4 was produced in the same manner as in Example 1.

[Reflection Spectra]

The reflectances of the photonic films of Examples 1 to 4 were measured for visible light, ultraviolet light and infrared light with the following apparatus under the following conditions.

Light source: DH2000-BAL deuterium halogen lamp manufactured by Ocean Optics

Spectroscope: QE-65000 manufactured by Ocean Optics

Exposure time: 8 ms

Measurement environment: dark room, room temperature

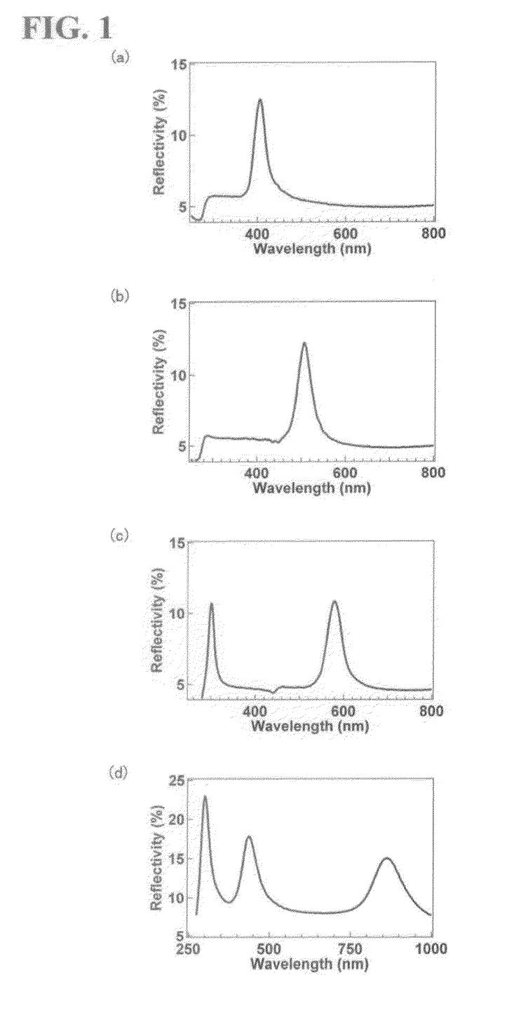

FIGS. 1(a) to 1(d) show reflection spectra. The photonic film of Example 1 reflected blue visible light of 406 nm. The photonic film of Example 2 reflected light of yellow green to blue green light of 507 nm. The photonic film of Example 3 reflected light of yellow light of 579 nm. Also, there appears a secondary peak at 302 nm, suggesting the presence of a lamellar structure. The photonic film of Example 4 reflected light of near-infrared light of 861 nm. Also, there appears a secondary peak at 436 nm and a tertiary peak at 300 nm, suggesting the presence of a lamellar structure as in Example 3. The appearance of the photonic film of Example 4 looked blue. In addition, it was confirmed that the photonic film of Example 1 reflected substantially the same light even after it was allowed to stand at room temperature in the air for about 100 days. It was also confirmed that the photonic films of Examples 2 to 4 reflected substantially the same light even after they were allowed to stand under such conditions.

[TEM Observation]

Another photonic film of Example 1 was formed for observing the nanophase-separated structure of the thin film before and after being swelled with an ionic liquid. The observation was performed through a transmission electron microscope (TEM). For forming the thin film, a polyimide film was used instead of the quartz slide glass. In order to turn the surface of the film hydrophilic, the film was subjected to alkali treatment by being immersed in 1 M KOH aqueous solution at 40° C. for 15 minutes. Then, the thin film before adding the ionic liquid and the thin film after adding the ionic liquid were each cut out and embedded in an epoxy resin. Then, ultra-thin film samples (thickness: 50 nm) were formed using microtome and disposed on a Cu grid. Then, the ultra-thin film samples were dyed with iodine for 40 minutes and were observed with the following TEM apparatus under the following conditions.

Apparatus: JEM-1400 manufactured by JEOL

Accelerating voltage: 120 kV

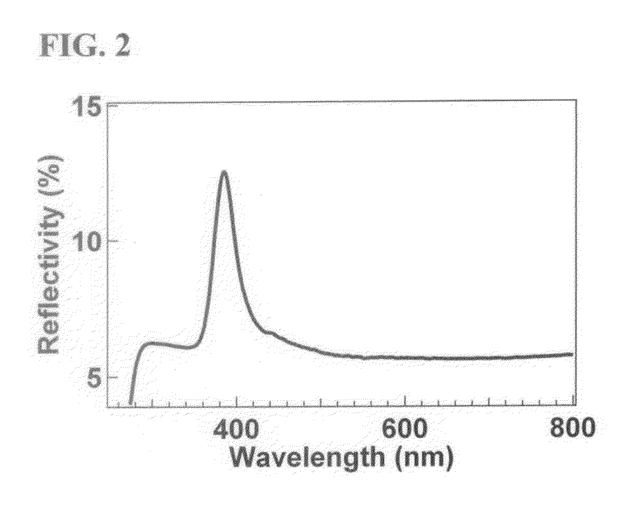

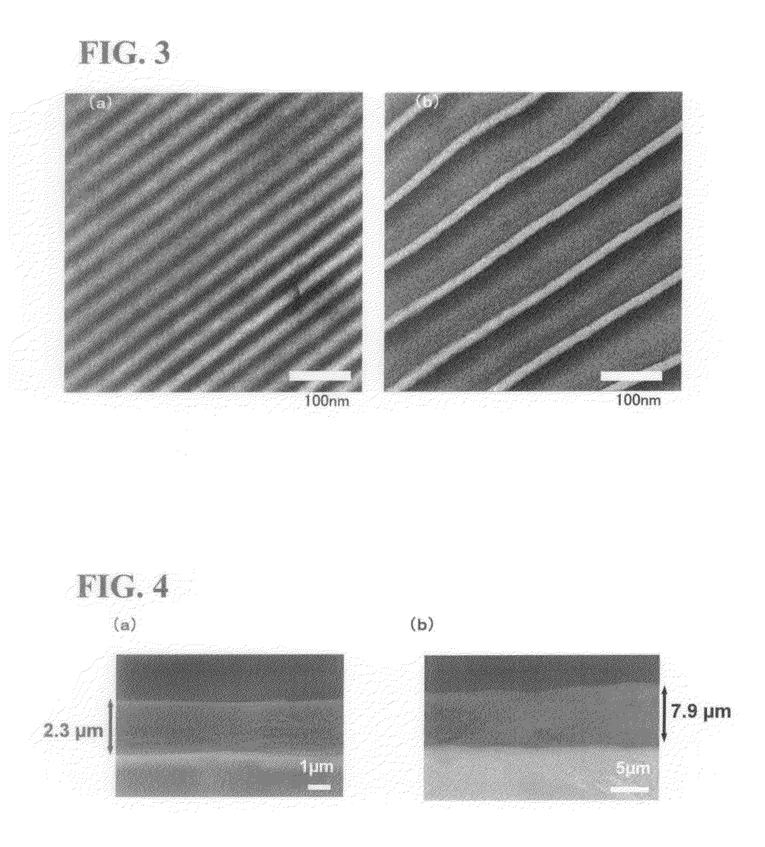

FIG. 3(a) is a TEM photograph before adding the ionic liquid, and FIG. 3(b) is a TEM photograph after adding the ionic liquid. In FIG. 2, white areas show polystyrene phases (PS phases), and black areas show poly(2-pyridine) phases (P2VP phases). From FIG. 3(a) of the thin film before adding the ionic liquid, the white areas had a thickness of 17 nm; the black areas had a thickness of 18 nm; and the sum of the two, that is, the repetition period D, was 35 nm. Also, from FIG. 3(b) of the thin film after adding the ionic liquid, the white areas had a thickness of 18 nm; the black areas had a thickness of 102 nm; and the sum of the two, that is, the repetition period D, was 120 nm. From these results, It was found that the thin film after adding the ionic liquid was swelled to a size about 3.4 times (=120 nm/35 nm) the thin film before adding the ionic liquid.

[FE-SEM Observation]

The same thin films as those in Example 1 before and after adding the ionic liquid were formed for measuring the thickness of the thin film before and after being swelled with the ionic liquid, and the thin films were measured using a field emission scanning electron microscope (FE-SEM). For forming the thin films, a cover glass was used instead of the quartz slide glass. The observation was performed under the following conditions using the following apparatus. FIG. 4(a) is an SEM photograph before adding the ionic liquid, and FIG. 4(b) is an SEM photograph after adding the ionic liquid. FIG. 4 shows that the thin film to which the ionic liquid had been added was swelled to 3.4 times (=7.9 μm/2.3 μm) as large as that before adding the ionic liquid.

Apparatus: JSM-7500FA manufactured by JEOL

Accelerating voltage: 1 kV

The fact that TEM micrographs and SEM micrographs were obtained suggests that the measurements were achieved in vacuum. This demonstrates that the ionic liquid used was non-volatile.

[SAXS Measurement]

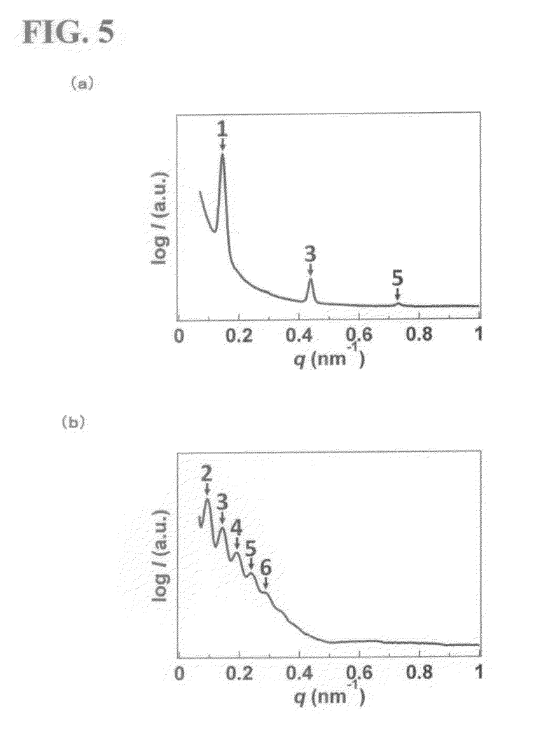

The same thin films as those in Example 1 before and after adding the ionic liquid were formed on a polyimide substrate for measuring the size of the structure before and after being swelled with the ionic liquid, and the thin films were subjected to small-angle X-ray scattering (SAXS) measurement. Films swelled with the ionic liquid and not swelled were prepared, and each was cut out as a test pieces for SAXS measurement. The measurement was performed using the following apparatus under the following conditions. FIG. 5(a) is an SAXS profile before adding the ionic liquid, and FIG. 5(b) is an SAXS profile after adding the ionic liquid. The SAXS profile of the test piece not swelled with the ionic liquid exhibited odd-order peaks. Accordingly, it was estimated that a lamellar structure of a composition containing two components with the same proportions had been formed. The repetition period D was 43 nm. For the SAXS profile of the test piece swelled with the ionic liquid, on the other hand, if the peak at the lowest q value is assumed to be secondary, the ratio of the q values of the subsequent peaks was 3:4:5:6. Accordingly, it was estimated that a lamellar structure had been formed although the primary peak was not visible and hidden. The repetition period was 138 nm. Thus it was found that the thin film to which the ionic liquid had been added was swelled to 3.2 times (=138 nm/43 nm) as large as that before adding the ionic liquid.

Apparatus: Photon Factory (PF) beamline 10C of High Energy Accelerator Research Organization (KEK)

X-ray beam wavelength: 0.15 nm

Camera length: 199 cm

### Comparative Example 1

A thin film was formed in the same manner as in Example except that EMITFSI (ethyl-3-methylimidazolium bis(trifluoromethylsulfonyl)imide, see Chem. 2) was used instead of ImHTFSI as the ionic liquid. The thin film however did not reflect light in a wavelength region from near-infrared light to near-ultraviolet light. The reason of this result is probably that ImHTFSI used in Example 1 was a protic ionic liquid, while EMITFSI used in Comparative Example 1 was aprotic ionic liquid. It is thought that the protic ionic liquid used for dissolving and swelling P2VP form a hydrogen bond with P2VP or ionically interacts with P2VP, whereas the aprotic ionic liquid does not act in such a manner and hence did not swell P2VP.

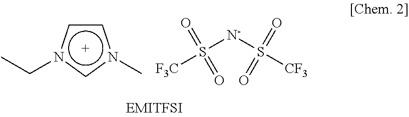

### Examples 5 to 9

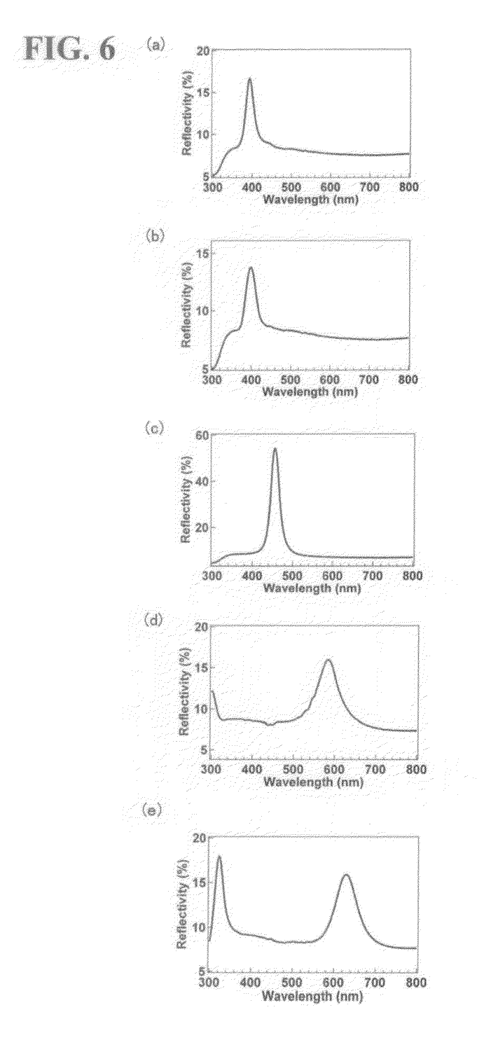

Five PS-P2VPs in total of 40.5 k-41 k, 40 k-44 k, 55 k-50 k, 84 k-69 k and 102 k-97 k were bought as the AB diblock copolymer from Polymer Source Inc., and photonic thin films were formed in the same manner as in the above-described Example 1. The polymers were named SP05, SP06, SP07, SP08 and SP09, respectively, and the processes of forming photonic films were performed in Examples 5 to 9, respectively. FIGS. 6(a) to 6(e) show the reflection spectra of these photonic films. The photonic film of Example 5 reflected blue violet light of 393 nm. The photonic film of Example 6 reflected blue violet light of 398 nm. The photonic film of Example 7 reflected blue light of 455 nm. The photonic film of Example 8 reflected yellow green light of 584 nm. The photonic film of Example 9 reflected red light of 629 nm. Also, the photonic film of Example 9 showed a secondary peak at 322 nm, suggesting the presence of a lamellar structure.

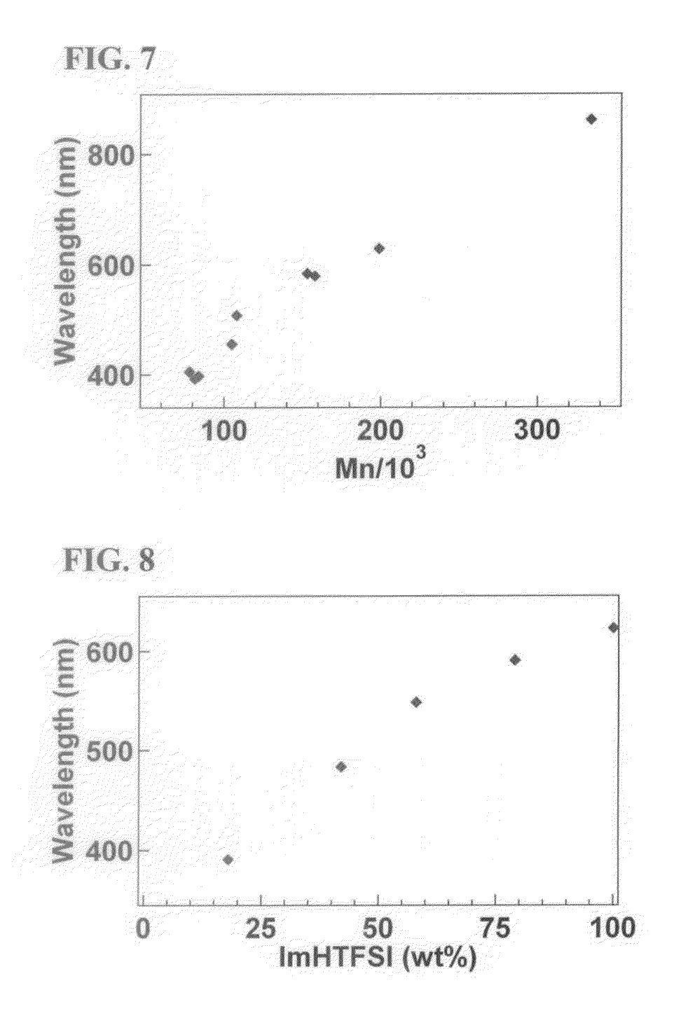

The number average molecular weight Mn, the volume fraction φs, and the peak wavelength λ (nm) in the reflection spectrum, of each photonic film in Examples 1 to 9 are shown together in Table 1. According to Table 1, a plot was prepared where the horizontal axis represents number-average molecular weight Mn and the vertical axis represents peak wavelength λ (nm). FIG. 7 shows the plot.

TABLE 1

| | | | PEAK |
|---|---|---|---|
| | NUMBER | | WAVELENGTH |
| | AVERAGE | | IN |
| | MOLECULAR | VOLUME | REFLECTION |
| | WEIGHT | FRACTION | SPECTRUM |
| | Mn | φs | λ (nm) |
| EXAMPLE 1 | 78k | 0.50 | 406 |
| EXAMPLE 2 | 108k | 0.47 | 507 |
| EXAMPLE 3 | 158k | 0.50 | 579 |
| EXAMPLE 4 | 334k | 0.51 | 861 |
| EXAMPLE 5 | 82k | 0.52 | 393 |
| EXAMPLE 6 | 84k | 0.49 | 398 |
| EXAMPLE 7 | 105k | 0.54 | 455 |
| EXAMPLE 8 | 153k | 0.57 | 584 |
| EXAMPLE 9 | 199k | 0.53 | 629 |

### Examples 10 to 13, Comparative Example 2

Photonic thin films were produced using the SP09 as the AB diblock copolymer in the same manner as in Example 1. For these photonic thin films, mixtures of ImHTFSI and EMITFSI with the proportions (in terms of weight) shown in Table 2 were used as the ionic liquid. The reflected light color and reflection spectrum of each of the resulting photonic thin films were measured. The results are shown in Table 2. As shown in Table 2, the film in the case of independently using EMITFSI (Comparative Example 2) did not reflect visible light, whereas the films in the case of independently using ImHTFSI (Example 9) or using a mixed solvent of ImHTFSI and EMITFSI (Examples 10 to 13) reflected visible light. These results suggest that a solvent containing a non-volatile protic solvent enables the resulting photonic film to reflect visible light. FIG. 8 is a plot showing the relationship between the ImHTFSI content (wt %) and the peak wavelength in reflection spectra. The ImTFSI content (wt %) represents the ratio of the weight of ImTFSI to the weight of the mixed solvent of EMITFSI and ImTFSI. As is clear from this figure, it has been found that as the ImHTFSI content is increased, the peak wavelength in the reflection spectrum increases. In other words, it has been found that the peak wavelength in a reflection spectrum can be controlled by the content of a non-volatile protic solvent ImHTFSI.

TABLE 2

| | | | PEAK |
|---|---|---|---|
| | | | WAVELENGTH |
| | | | IN |
| | lmTFSI:EMITFSI | COLOR OF | REFLECTION |
| | (WEIGHT | REFLECTED | SPECTRUM |
| | RATIO) | LIGHT | λ (nm) |
| EXAMPLE 9 | 10:0 | RED | 629 |
| EXAMPLE 10 | 8:2 | YELLOW | 591 |
| | | GREEN | |
| EXAMPLE 11 | 6:4 | BLUE GREEN | 549 |
| EXAMPLE 12 | 4:6 | BLUE | 484 |
| EXAMPLE 13 | 2:8 | BLUE | 391 |
| | | VIOLET | |
| COMPARATIVE | 0:10 | — | — |
| EXAMPLE 2 | | | |

### Examples 14 and 15

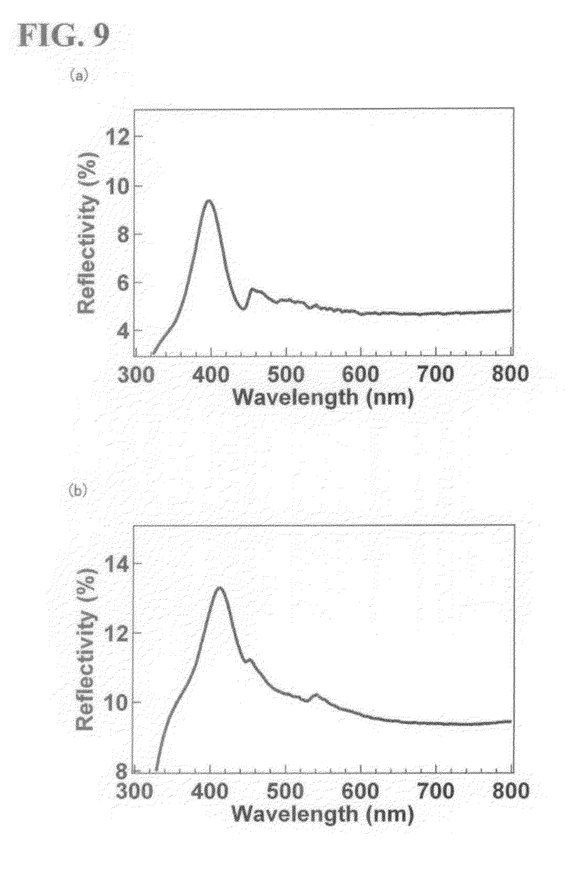

In Example 14, a photonic film was formed in the same manner as in Example 1, except that a triazole salt TAZHTFSI (see Chem. 3) was used as the ionic liquid. In Example 15, a photonic film was formed in the same manner as in Example 1, except that a methylimidazolium salt MImHTFSI (see Chem. 3) was used as the ionic liquid. FIGS. 9(a) and 9(b) show the reflection spectra of these photonic films. Both the photonic films were swelled with the ionic liquid. Also, it was confirmed that the film of Example 14 reflected visible light of 396 nm, and that the film of Example 15 reflected visible light of 411 nm. TAZHTFSI is a colorless and transparent liquid with Tm=22.8° C., and MImHTFSI is a colorless and transparent liquid with Tm=9° C.

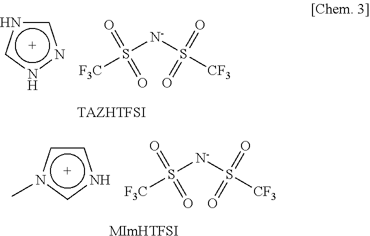

### Examples 16 and 17

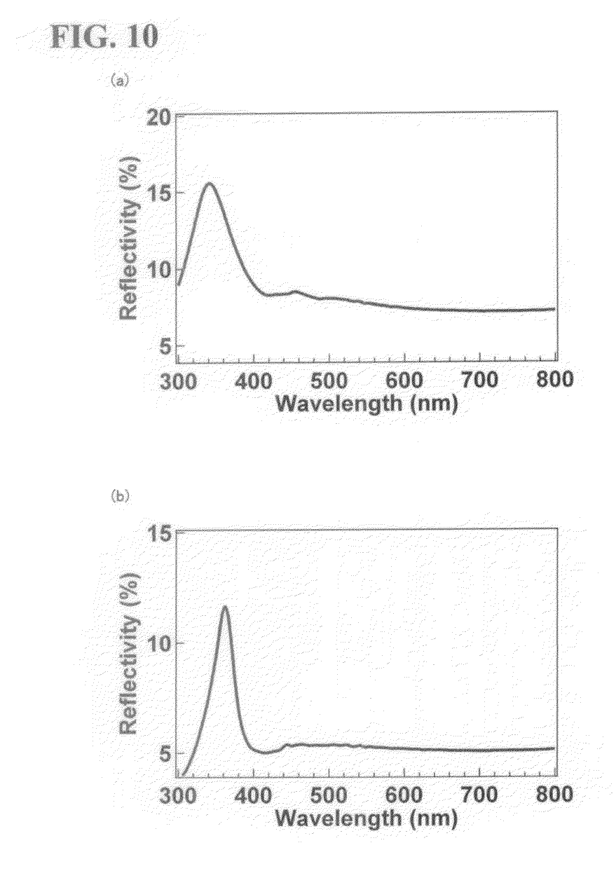

In Example 16, a photonic film was formed in the same manner as in Example 1, except that TEATFSI (see Chem. 4) that is an ammonium salt of a tertiary amine was used as the ionic liquid. In Example 17, a photonic film was formed in the same manner as in Example 1, except that tBATfO (see Chem. 4) that is an ammonium salt of a tertiary amine was used as the ionic liquid. FIGS. 10(a) and 10(b) show the reflection spectra of these photonic films. Both the photonic films were swelled with the ionic liquid. Also, it was confirmed that the film of Example 16 reflected light of 341 nm, and that the film of Example 17 reflected light of 361 nm. TEATFSI is a colorless and transparent liquid, and tBATfO is a colorless and transparent liquid.

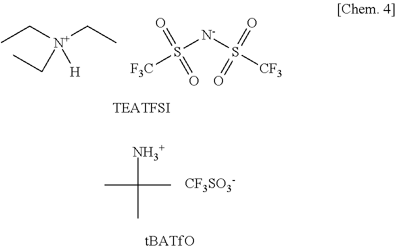

### Example 18 and 19

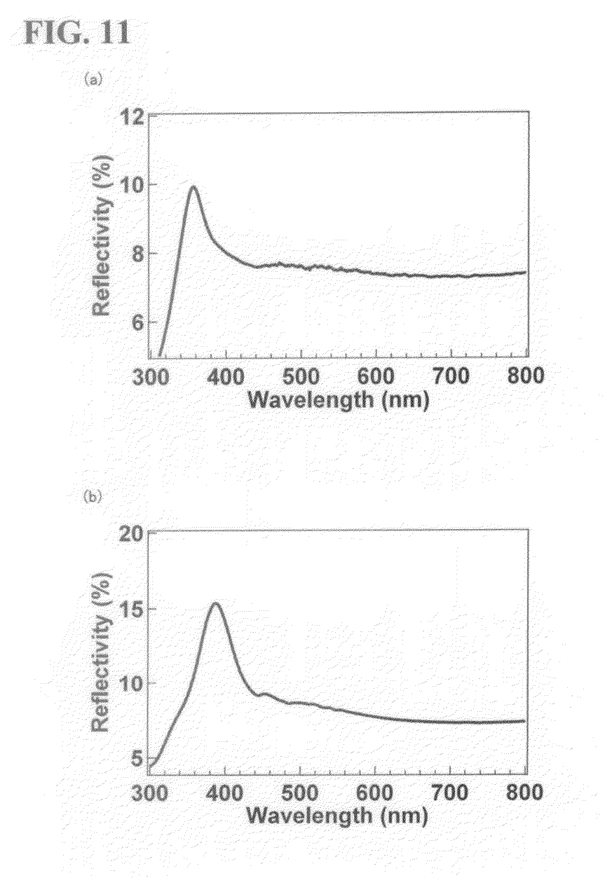

In Example 18, a photonic film was formed in the same manner as in Example 1, except that a pyridinium salt 2MPyTFA (see Chem. 5) was used as the ionic liquid. In Example 19, a photonic film was formed in the same manner as in Example 1, except that an ethylimidazolium salt EImTfO (see Chem. 5) was used as the ionic liquid. FIGS. 11(a) and 11(b) show the reflection spectra of these photonic films. Both the photonic films were swelled with the ionic liquid. Also, it was confirmed that the film of Example 18 reflected light of 356 nm, and that the film of Example 19 reflected light of 387 nm. 2MPyTFA was a pale yellow liquid, and EImTfO is a colorless and transparent liquid.

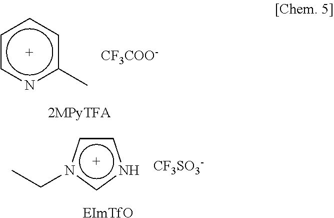

### Example 20

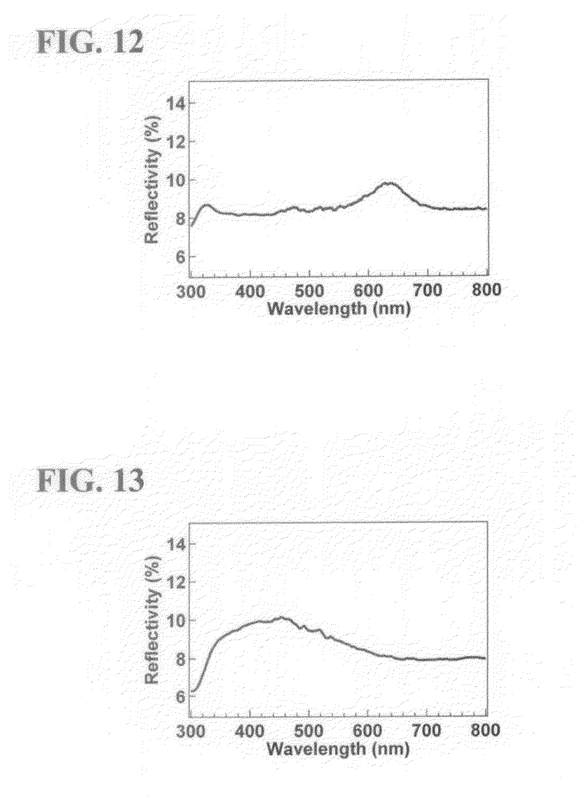

A polystyrene-poly(methyl methacrylate) (hereinafter referred to as “PS-PMMA”) of 80 k-80 k was bought as the AB diblock copolymer from Polymer Source Inc. Then a photonic film of Example 20 was formed using this PS-PMMA and ImHTFSI in the same manner as in Example 1. FIG. 12 shows a reflection spectrum. It was confirmed that the film reflected light of 637 nm. This photonic film reflected red visible light.

### Example 21

A PS-PMMA of 66 k-63.5 k was bought as the AB diblock copolymer from Polymer Source Inc. Then a photonic film of Example 21 was formed using this PS-PMMA and ImHTFSI in the same manner as in Example 1. FIG. 13 shows a reflection spectrum. Since an irregularity was observed at the surface of the thin film, a sharp peak was not exhibited, although it was confirmed that the film reflected light of wavelengths around 453 nm. This photonic film reflected blue visible light.

### Comparative Examples 3 to 11

Films were formed in the same manner as in Example 1 except that EHIBr, EPyTFSI, EMIBF4, and TOMAC (see Chem. 6) were used instead of ImHTFSI, for forming photonic films (Comparative Examples 3 to 6). The resulting films however did not reflect visible light. Also, films were formed in the same manner as in Example 20 except that EMITFSI, EHIBr, EPyTFSI, EMIBF4, and TOMAC were used instead of ImHTFSI, for forming photonic films (Comparative Examples 7 to 11). The resulting films however did not reflect visible light. The reason of these results is probably that ImHTFSI used in Examples 1 and 20 was a protic ionic liquid, while EMITFSI used in Comparative Example 3 was aprotic ionic liquid. It is thought that the protic ionic liquids used for swelling P2VP or PMMA form a hydrogen bond with P2VP or PMMA or ionically interacts therewith, whereas aprotic ionic liquids do not act in such a manner and hence did not swell P2VP or PMMA.

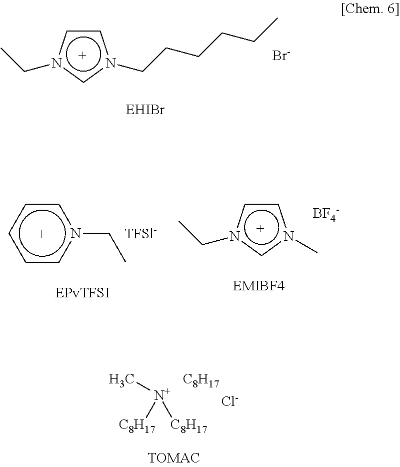

The reflectances of the photonic films were different among the Examples, as described above. This is probably because the reflectance depends on the quality of the photonic film (how many repetitions of the period of a nanostructure, whether the repetition units are the same and are not irregular, whether the surface is not rough, whether the interface is sufficiently narrow, and the like). Incidentally, the reflectance varies among positions in the same photonic film.

This application claims the benefit of Japanese Patent Application No. 2013-101409 filed on May 13, 2013, which is hereby incorporated by reference herein in its entirety.

It should be appreciated that the above-described Examples are not intended to limit the invention.

### INDUSTRIAL APPLICABILITY

The present invention can be applied to optical filters, polarizers, wave plates, and the like.

1. A non-volatile photonic material capable of reflecting part of the light rays in a wavelength region from near-ultraviolet light to near-infrared light, the non-volatile photonic material comprising:
a block copolymer including a plurality of different polymer chains connected to one another, where each polymer chain is independently aggregated, forming a nanophase separated structure,
wherein at least one of the plurality of different polymer chains is swelled with a non-volatile solvent.

2. The non-volatile photonic material according to claim 1,
wherein the photonic material reflects a part of the light rays in a wavelength region of visible light.

3. The non-volatile photonic material according to claim claim 1,
wherein the non-volatile solvent is a non-volatile protic solvent or a non-volatile solvent containing the non-volatile protic solvent.

4. The non-volatile photonic material according to claim 1,
wherein the non-volatile solvent is a protic ionic liquid or a non-volatile solvent containing the protic ionic liquid.

5. The non-volatile photonic material according to claim 1,
wherein the non-volatile protic solvent is an ionic liquid made up of a salt of a nitrogen-containing heterocycle having a proton on the nitrogen thereof or an ionic liquid made up of an ammonium salt of an organic amine having a proton on the nitrogen thereof.

6. The non-volatile photonic material according to claim 5,
wherein the nitrogen-containing heterocycle is imidazole, triazole or pyridine.

7. The non-volatile photonic material according to claim 1,
wherein the plurality of different polymer chains include a first polymer chain and a second polymer chain, and
the second polymer chain is swelled to a larger size with the non-volatile solvent than the first polymer chain.

8. The non-volatile photonic material according to claim 7,
wherein the first polymer chain is a polystyrene chain, and
the second polymer chain is a polyvinylpyridine chain or a polymethacrylic acid ester.

9. A method for producing a non-volatile photonic material capable of reflecting a part of the light rays in a wavelength region from near-ultraviolet light to near-infrared light, the method comprising:
forming a thin film on a substrate using a solution containing a block copolymer including a plurality of different polymer chains connected to one another, and swelling the thin film with a non-volatile solvent.

10. The method for producing the non-volatile photonic material according to claim 9,
wherein the photonic material reflects a part of the light rays in a wavelength region of visible light.

11. The method for producing the non-volatile photonic material according to claim 9,
wherein the non-volatile solvent is a non-volatile protic solvent or a non-volatile solvent containing the non-volatile protic solvent.

12. The method for producing the non-volatile photonic material according to claim 9,
wherein the non-volatile solvent is a protic ionic liquid or a non-volatile solvent containing the protic ionic liquid.

13. The method for producing the non-volatile photonic material according to claim 9,
wherein the non-volatile protic solvent is an ionic liquid made up of a salt of a nitrogen-containing heterocycle having a proton on the nitrogen thereof or an ionic liquid made up of an ammonium salt of an organic amine having a proton on the nitrogen thereof.

14. The method for producing the non-volatile photonic material according to claim 13,
wherein the nitrogen-containing heterocycle is imidazole, triazole or pyridine.

15. The method for producing the non-volatile photonic material according to claim 9,
wherein the plurality of different polymer chains include a first polymer chain and a second polymer chain, and
the second polymer chain is swelled to a larger size with the non-volatile solvent than the first polymer chain.

16. The method for producing the non-volatile photonic material according to claim 15,
wherein the first polymer chain is a polystyrene chain, and
the second polymer chain is a polyvinylpyridine chain or a polymethacrylic acid ester.

17. The non-volatile photonic material according to claim 1,
wherein either the non-volatile solvent or the swollen polymer chain is protic.

18. The method for producing the non-volatile photonic material according to claim 9,
wherein either the non-volatile solvent or the swollen polymer chain is protic.
